(19) United States
(12) Patent Application Publication
(10) Pub. No.: US 2014/0243043 A1
(43) Pub. Date: Aug. 28, 2014

(54) UNIVERSAL SMALL CELL BACKHAUL RADIO ARCHITECTURE

(71) Applicant: ZTE (USA) INC., Richardson, TX (US)

(72) Inventors: Ying SHEN, Chapel Hill, NC (US); Edwin Nealis, Cary, NC (US)

(73) Assignee: ZTE (USA) INC., Richardson, TX (US)

(21) Appl. No.: 14/178,709

(22) Filed: Feb. 12, 2014

Related U.S. Application Data
(60) Provisional application No. 61/769,640, filed on Feb. 26, 2013.

(51) Int. Cl. H04B 7/04; H04W 88/10

(52) U.S. Cl. CPC H04B 7/043; H04W 88/10
USPC 455/553.1

(57) ABSTRACT

A dual-band small cell backhaul radio comprises a first communication channel including multiple non-line of sight (NLOS) Sub-6 GHz antennas, a second communication channel including a line of sight (LOS) 60 GHz or E-band antenna, circuitry for managing the first communication channel and the second communication channel, and an interface for providing data and power from a small cell to the first communication channel and the second communication channel, respectively.

### RELATED APPLICATION

The present application claims priority to U.S. Provisional Application No. 61/769,640, “UNIVERSAL SMALL CELL BACKHAUL RADIO ARCHITECTURE,” filed Feb. 26, 2013, which is hereby incorporated by reference in its entirety.

### TECHNICAL FIELD

The disclosed implementations relate generally to wireless communication, and in particular, to universal small cell backhaul radio architecture.

### BACKGROUND

The wide spread of mobile devices (e.g., smartphones) has resulted in an explosion of mobile data usage. Many techniques have been proposed for reducing the latency caused by the mobile data surge, one of which is to deploy a large number of small cells within a cellular network comprised of macro cells so that the data originally targeted for the macro cells is now offloaded to the small cells. But the data offloaded by the small cells ultimately will find its way to the backbone of the cellular network, which requires that the small cells be connected to the macro cells or each other via backhaul links. Although optical fiber may be desired for connecting one small cell to another small or macro cell, this option is not always feasible due to the unavailability of the optical fiber connection.

### SUMMARY

In accordance with some implementations described below, a dual-band small cell backhaul radio comprises a first communication channel including multiple non-line of sight (NLOS) Sub-6 GHz antennas, a second communication channel including a line of sight (LOS) 60 GHz or E-band antenna, circuitry for managing the first communication channel and the second communication channel, and an interface for providing data and power from a small cell to the first communication channel and the second communication channel, respectively.

In some implementations, the first communication channel further includes: a Sub-6 GHz MIMO modem and multiple RF transceivers, each RF transceiver configured for coupling a respective NLOS Sub-6 GHz antenna to the Sub-6 GHz MIMO modem. The second communication channel further includes a 60 GHz or E-band modem and a 60 GHz or E-band RF transceiver configured for coupling the LOS 60 GHz or E-band antenna to the 60 GHz or E-band modem. The circuitry for managing the first communication channel and the second communication channel includes: (i) a microcontroller unit for controlling components associated with the NLOS Sub-6 GHz antennas and the LOS 60 GHz or E-band antenna, respectively, (ii) a FPGA-based network processor for processing data packets to/from the small cell, (iii) a SyncE/1588 synchronizer for synchronizing timing, phase, and frequency of the data packets, (iv) a memory device for storing modules and data supporting the microcontroller unit and the network processor, and (v) a circuit for receiving power over the Ethernet from the small cell and using the power to power the NLOS Sub-6 GHz antennas and the LOS 60 GHz or E-band antenna and their associated components.

In some implementations, the NLOS Sub-6 GHz antennas include four dipole antennas arranged in a 2×2 matrix and the LOS 60 GHz or E-band antenna includes a flat antenna located within a region defined by the 2×2 matrix of the four dipole antennas. The NLOS Sub-6 GHz antennas include four microstrip antennas defining a square region and the LOS 60 GHz or E-band antenna includes a flat antenna located within the square region.

In some implementations, the dual-band small cell backhaul radio further includes a 2-axis active alignment bracket assembly. The assembly is mechanically tunable to align the NLOS Sub-6 GHz antennas and the LOS 60 GHz or E-band antenna with counterparts of another small cell backhaul radio. The LOS 60 GHz or E-band antenna further includes a plurality of antennas and a phase and amplitude network coupled to the plurality of antennas. The phase and amplitude network being electrically tunable to align the plurality of antennas with counterparts of another small cell backhaul radio. Sometimes, the LOS 60 GHz or E-band antenna further includes a plurality of antennas, each antenna being aligned with a counterpart of another small cell backhaul radio using digital beam forming.

In some implementations, the NLOS Sub-6 GHz antennas have an operating frequency selected from the group consisting of 2.4 GHz, 2.6 GHz, 3.5 GHz, 5 GHz, 5.4 GHz, and 5.8 GHz. The first communication channel has a data transmission capacity of up to 600 Mbps and a channel bandwidth ranging from 10 MHz to 40 MHz. The second communication channel has a data transmission capacity of at least 2.5 Gbps and a channel bandwidth ranging from 250 MHz to 500 MHz.

In some implementations, the first communication channel and the second communication channel are configured to operate simultaneously. The circuitry is configured to perform an automatic hitless switching from one of the first communication channel and the second communication channel and the other one of the first communication channel and the second communication channel when a predefined condition is met, e.g., when a respective communication channel stops working due to a band interference, a blockage, multipath fading, and hardware failure.

### BRIEF DESCRIPTION OF DRAWINGS

The aforementioned implementation of the invention as well as additional implementations will be more clearly understood as a result of the following detailed description of the various aspects of the invention when taken in conjunction with the drawings. Like reference numerals refer to corresponding parts throughout the several views of the drawings.

FIG. 1 is a block diagram illustrating two small cells and their associated backhaul radios according to some implementations of the present application.

FIG. 2 is a block diagram of the radio-frequency (RF) spectrum allocated for wireless communication.

FIGS. 3A and 3B illustrate the structure of a dual-band small cell backhaul radio according to some implementations of the present application.

FIGS. 4A and 4B are two exemplary configurations of the NLOS Sub-6 GHz antennas according to some implementations of the present application.

FIGS. 5A and 5B are two exemplary configurations of using a 2-axis active alignment bracket assembly for mechanically tuning the dual-band small cell backhaul radio according to some implementations of the present application.

FIG. 6A depicts two exemplary configurations of electrical beam steering for electrically tuning multiple LOS 60 GHz or E-band antennas in the dual-band small cell backhaul radio according to some implementations of the present application.

FIG. 6B is an exemplary configuration of using a electrical beam steering for electrically tuning multiple LOS 60 GHz or E-band antennas in the dual-band small cell backhaul radio according to some implementations of the present application.

FIG. 7 is a block diagram illustrating the internal structure of a dual-band small cell backhaul radio according to some implementations of the present application.

### DETAILED DESCRIPTION

The present application is directed to universal dual-band small cell backhaul radio architecture to address at least some of the issues associated with mobile data offloading using small cells. Compared with the conventional approaches, this architecture provides a low-cost, easy-to-install, and large throughput solution for connecting different small cells.

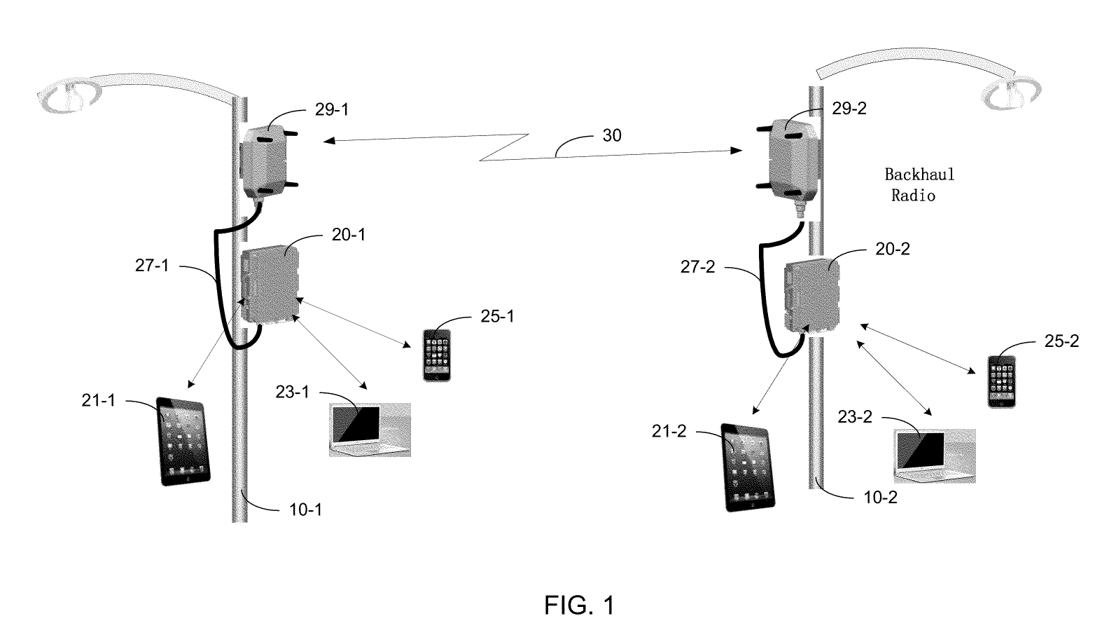

FIG. 1 is a block diagram illustrating two small cells and their associated backhaul radios according to some implementations of the present application. In this example, there are two small cells 20-1 and 20-2. The small cell 20-1 is attached to a light pole 10-1 and the small cell 20-2 is attached to a light pole 10-2. Each small cell exchanges data with multiple mobile communication devices including tablets (21-1 and 21-2), laptops (23-1 and 23-2), and smartphones (25-1 and 25-2) within a predefined distance from the small cell using cellular technologies or Wi-Fi or the like. Besides the two small cells, there are two backhaul radios 29-1 and 29-2 attached to the two light poles 10-1 and 10-2, respectively, each coupled to a respective small cell (20-1 or 20-2) via a cable (27-1 or 27-2). The two backhaul radios 29-1 and 29-2 are configured to communicate with each other wirelessly through a backhaul link 30. The subsequent description provides more details of a backhaul radio used for connecting a corresponding small cell to the rest of the cellular network.

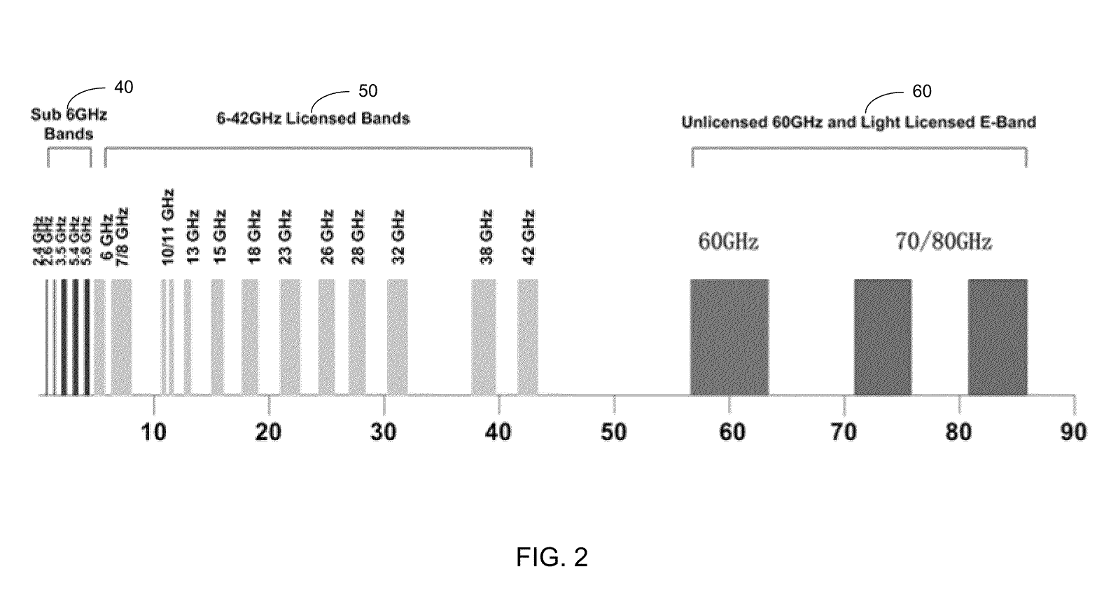

Although optical fiber is a good choice for backhaul links in many cases, this option is always available due to various restrictions like monetary and time cost and government regulations. Besides the optical fiber, backhaul radio is often a good alternative for wireless applications like small cells. Of course, an important consideration of using the backhaul radio to connect different small cells is the choice of frequency band. FIG. 2 is a block diagram of the radio-frequency (RF) spectrum allocated for microwave radio applications. The spectrum has a bandwidth of approximately 90 GHz and it is divided into three groups of frequency bands: (i) Sub-6 GHz bands 40; (ii) 6-42 GHz licensed bands 50; and (iii) Unlicensed 60 GHz and lightly-licensed E-bands 60. As shown in the figure, there are multiple frequency bands within each group. For example, the Sub-6 GHz bands 40 include the following frequencies: 2.4 GHz, 2.6 GHz, 3.5 GHz, 5 GHz, 5.4 GHz, and 5.8 GHz.

When choosing a frequency band for the backhaul radio of a small cell, there are at least three considerations. First, the frequency band should not be very close to those heavily-licensed frequency bands because the small cell is typically deployed on the street level and the standard large parabolic antenna used for the heavily-licensed frequency bands should be avoided as much as possible. Moreover, the small cells are considered as a part of a city digital infrastructure and the large antenna may destroy the city's image. Second, the frequency band should have sufficient bandwidth for supporting the throughput at the small cell. Finally, the frequency band or bands chosen for the small cell backhaul radio should be able to work or recover from various types of adverse situations such as band interference, blockage, multipath fading, or hardware breakdown. Based on multiple factors, the following two frequency bands are chosen for the backhaul radio: (i) a first frequency band of the Sub-6 GHz bands 40 and (ii) a second frequency band of the Unlicensed 60 GHz and lightly-licensed E-bands 60.

The Sub-6 GHz bands 40 support the non-line of sight (NLOS) propagation of microwave signals. Obstacles that commonly cause NLOS conditions include buildings, trees, hills, mountains, and, in some cases, high voltage electric power lines. Some of these obstructions reflect certain radio frequencies, while some simply absorb or garble the signals; but, in either case, they limit the use of many types of radio transmissions, especially when low on power budget. Lower power levels at receiver give less space for correctly picking the transmission. As will be described below, one or more NLOS Sub-6 GHz multiple-input/multiple-output (MIMO) antennas are installed in the backhaul radio for supporting the NLOS propagation. In some implementations, an NLOS Sub-6 GHz MIMO antenna can use one of these potential frequency bands at 2.4 GHz, 2.6 GHz, 3.5 GHz, 5 GHz, 5.4 GHz and 5.8 GHz. Due to its non line of sight, the antenna has many desired features such as easy planning, easy installation with ubiquitous reach. On the other hand, the NLOS Sub-6 GHz MIMO antenna tends to have a narrow channel bandwidth ranging from 10 to 40 MHz, adversely affecting the antenna's throughput. In addition, the NLOS Sub-6 GHz MIMO antenna is also more vulnerable to the co-channel interference and strong shadow fading, etc.

The Unlicensed 60 GHz and lightly-licensed E-bands 60 supplement the Sub-6 GHz bands 40 in many aspects. For example, the unlicensed 60 GHz and lightly-licensed E-bands 60 support the line of sight (LOS) propagation of microwave signals. As will be described below, a LOS 60 GHz or E-band antenna is included in the backhaul radio for supporting the LOS propagation. The point-to-point backhaul radio at 60 GHz or E-band at 70-86 GHz provides a channel bandwidth ranging from 250 MHz to 500 MHz and above and supports a data traffic capacity of 2.5 Gbps or higher. Backhaul radios in the unlicensed 60 GHz band and the lightly-license E-band offer a high frequency reuse and minimum frequency planning due to their fast attenuation and high oxygen absorption. These millimeter-wave backhaul radios are more immune from the interference with little selective fading and fog attenuation and can be installed easily at a reasonable cost. Compared with the Sub-6 GHz bands 40, the unlicensed 60 GHz and lightly-licensed E-bands 60 have limited reach defined by the line of sight.

In sum, a backhaul radio supporting the two frequency bands is not only easy to manufacture and install but also provides a reasonable coverage in terms of LOS and NLOS at a reasonable cost. Assuming that the requirements for a small cell backhaul radio are a maximum 400-meter link distance and maximum availability of 99.99%, the 5 GHz and 60 GHz are two desired frequency bands for the small cell backhaul applications. For example, both the 5 GHz and 60 GHz are license-free frequency bands and they are available for use almost anywhere the world. The 5 GHz time division duplex (TDD) can support a data throughput of up to 600 Mbps with the 4×4 MIMO scheme and the 60 GHz frequency division duplex (FDD) can support the data throughput of up to 2.5 Gbps and above.

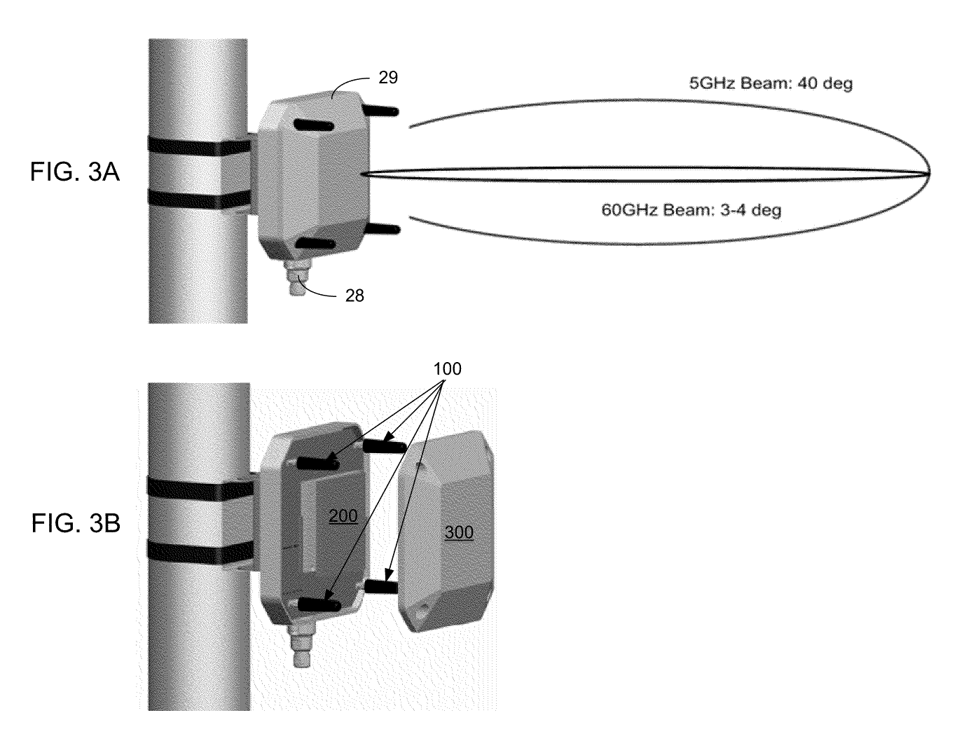

FIGS. 3A and 3B illustrate the structure of a dual-band small cell backhaul radio 29 according to some implementations of the present application. As shown in FIG. 3A, this backhaul radio 29 supports two frequency bands, 5 GHz and 60 GHz, and the backhaul radio 29 generates two radio beams, the NLOS 5 GHz having a beam angle of 40° and the LOS 60 GHz beam having a beam angle of 3-4°. The backhaul radio 29 includes an interface 28 through which the backhaul radio is connected to a small cell (see, e.g., FIG. 1). FIG. 3B is an exploded view of the internal structure of the dual-band small cell backhaul radio 29 including four 5 GHz dipole antennas 100 and a 60 GHz flat antenna 200. The 5 GHz dipole antennas 100 are exposed outside the cover by extending through one of four through holes located at the four corners of the cover 300 and the four antennas are configured for establishing an NLOS communication channel with the counterpart of a neighboring small cell backhaul radio. Similarly, the 60 GHz flat antenna 200 is configured for establishing a LOS communication channel with the counterpart of the neighboring small cell backhaul radio. Note that the flat antenna can avoid the public's perception of traditional parabolic antenna and provides a clean integrated future digital infrastructure of a city.

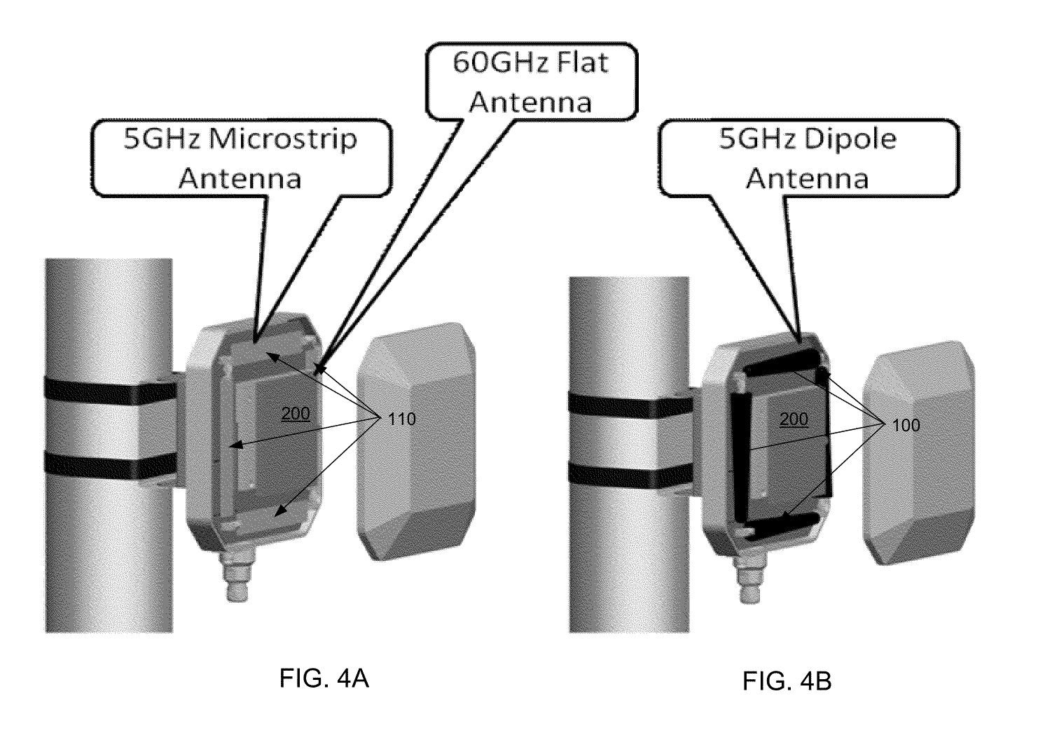

FIGS. 4A and 4B are two exemplary configurations of the NLOS Sub-6 GHz antennas according to some implementations of the present application. In these two examples, the 60 GHz flat antenna 200 remains the same. In FIG. 4A, the 5 GHz dipole antennas 100 shown in FIG. 3B are now replaced with four 5 GHz microstrip antennas 110. In FIG. 4B, the 5 GHz dipole antennas 100 shown in FIG. 3B are in the backhaul radio. But instead of sticking out of the cover 300, they are inside the box. Other than the differences in shape, the operations of the backhaul radio shown in FIGS. 4A and 4B is substantially similar to the one described above in connection with FIGS. 3A and 3B.

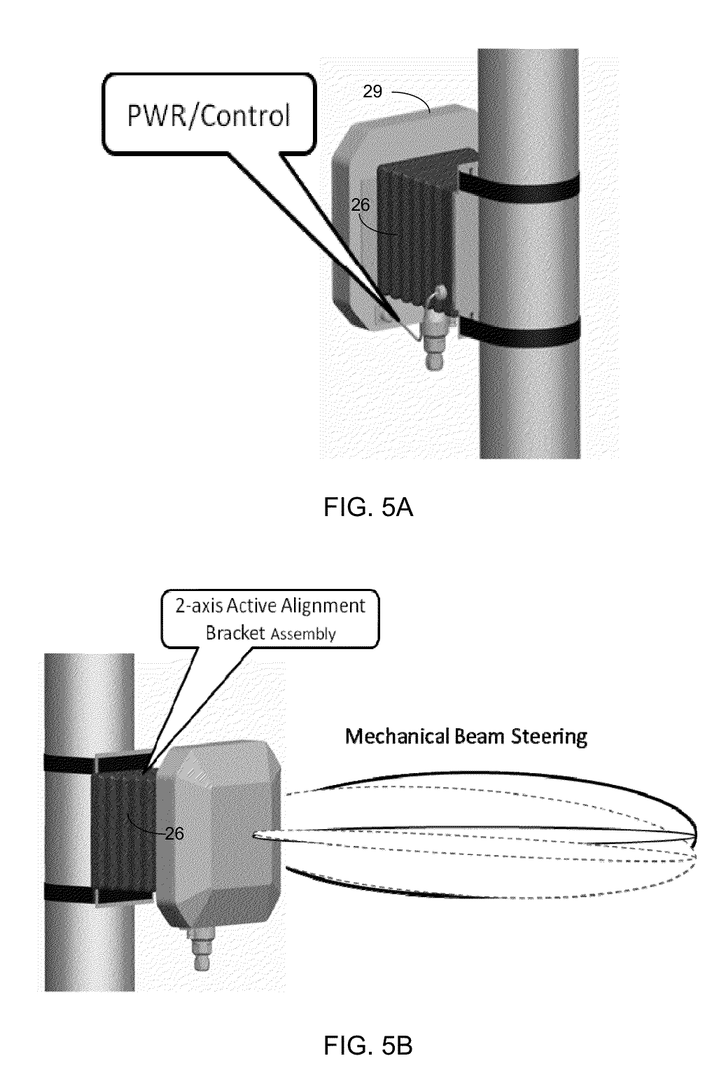

An important consideration of using the backhaul radio for small cell is its easy installation and easy tuning FIGS. 5A and 5B are two exemplary configurations of using a 2-axis active alignment bracket assembly 26 for mechanically tuning the dual-band small cell backhaul radio according to some implementations of the present application. The 2-axis active alignment bracket assembly can significantly reduce the installation/calibration time and improve the backhaul radio's availability and reliability even under severe weather conditions and multipath, etc. As shown in FIG. 5A, the backhaul radio 29 provides the power (e.g., DC) and control signals to the 2-axis active alignment bracket assembly 26. As shown in FIG. 5B, in response to the control signals, the 2-axis active alignment bracket assembly 26 automatically steers the beam angles of the two sets of antennas in the backhaul radio so as to automatically aligns itself with the other backhaul radio supporting a neighboring small cell or macro cell to enhance the backhaul radio link's performance.

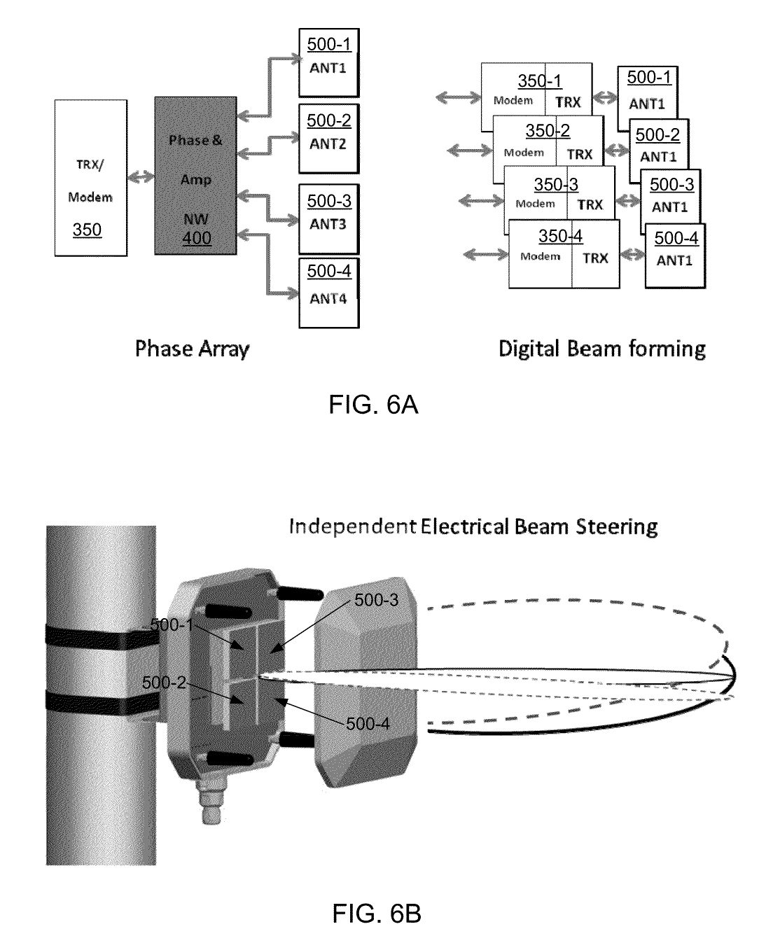

In some implementations, electrical beam steering is used for optimizing the backhaul radio's performance. FIG. 6A depicts two exemplary configurations of electrical beam steering for electrically tuning multiple LOS 60 GHz or E-band antennas in the dual-band small cell backhaul radio according to some implementations of the present application. As shown in the figure, one configuration is a phase array-based approach using a phase and amplitude network 400 to couple the transceiver/modem 350 to four 60 GHz antennas (500-1 to 500-4). The other configuration uses digital beam forming and each of the four 60 GHz antennas 500-1 to 500-4 is directly coupled to a set of transceiver/modem (350-1 to 350-4). FIG. 6B is an exemplary configuration of using a electrical beam steering for electrically tuning multiple LOS 60 GHz or E-band antennas in the dual-band small cell backhaul radio according to some implementations of the present application. In this example, the four 60 GHz flat antennas (500-1 to 500-4) are independently tuned to have the same or different beam angles so as to achieve an optimized result when communicating with a neighboring backhaul radio at the same frequency band.

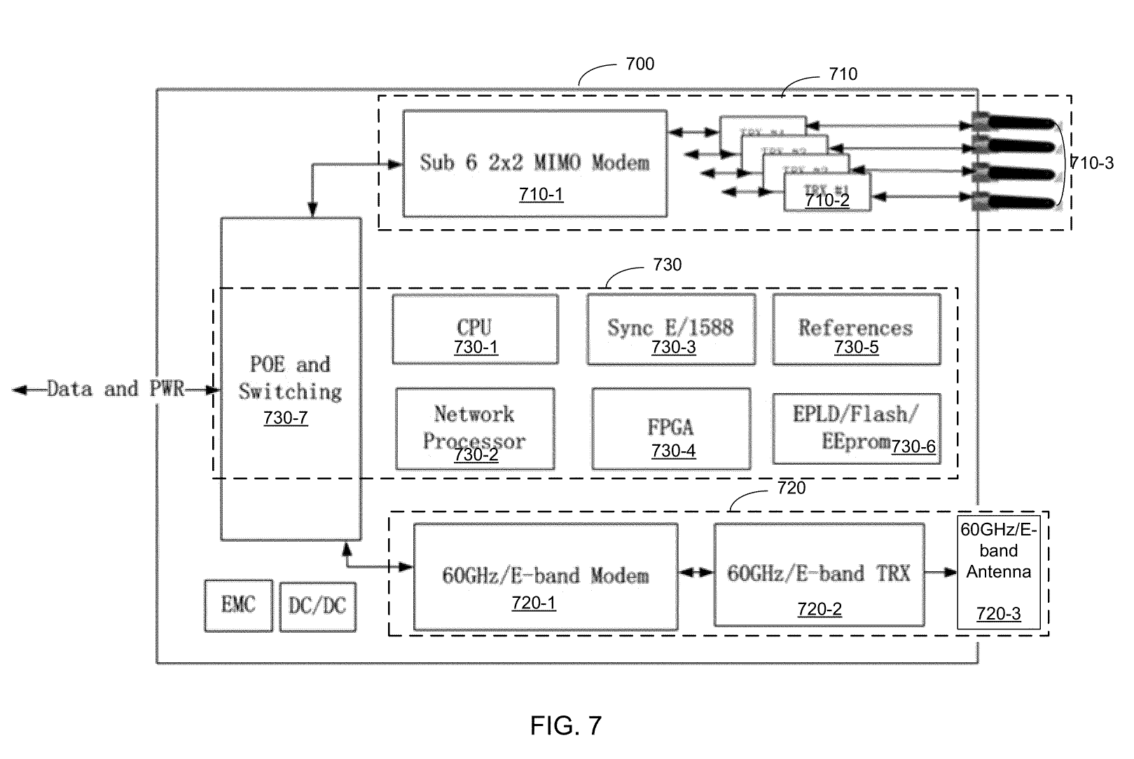

FIG. 7 is a block diagram illustrating the internal structure of a dual-band small cell backhaul radio 700 according to some implementations of the present application. The dual-band small cell backhaul radio 700 includes a first communication channel 710 including multiple non-line of sight (NLOS) Sub-6 GHz antennas 710-3 and a second communication channel 720 including a line of sight (LOS) 60 GHz or E-band antenna 720-3. In addition, the dual-band small cell backhaul radio 700 includes circuitry 730 for managing the first communication channel and the second communication channel and an interface for providing data and power from a small cell to the first communication channel and the second communication channel, respectively.

In this example, the first communication channel 710 further includes a Sub-6 GHz 2×2 MIMO modem 710-1 and multiple RF transceivers 710-2. Note that each RF transceiver is configured for coupling a respective NLOS Sub-6 GHz antenna 710-3 to a corresponding channel of the Sub-6 GHz 2×2 MIMO modem 710-1. The second communication channel 720 further includes a 60 GHz or E-band modem 720-1 and a 60 GHz or E-band RF transceiver 720-2. The transceiver 720-2 is configured for coupling the LOS 60 GHz or E-band antenna 720-3 to the 60 GHz or E-band modem 720-1.

The circuitry for managing the first communication channel 710 and the second communication channel 720 includes a CPU or a microcontroller unit (MCU) 730-1, a FPGA-based network processor 730-2, a SyncE/1588 synchronizer 730-3, a memory device 730-6, and a circuit 730-7. The CPU/MCU 730-1 controls components associated with the NLOS Sub-6 GHz antennas 710-3 and the LOS 60 GHz or E-band antenna 720-3, respectively. The FPGA-based network processor 730-2 is responsible for processing data packets to/from the small cell (not shown in FIG. 7). The SyncE/1588 synchronizer 730-3 is responsible for synchronizing timing, phase, and frequency of the data packets and the memory device 730-6 is used for storing modules and data supporting the CPU/MCU 730-1 and the network processor 730-2. The circuit 730-7 receives power over the Ethernet from the small cell and uses the power to power the NLOS Sub-6 GHz antennas 710-3 and the LOS 60 GHz or E-band antenna 720-3 as well as other components in the dual-band small cell backhaul radio 700. As described above in connection with FIG. 3B, the NLOS Sub-6 GHz antennas 710-3 include four dipole antennas arranged in a 2×2 matrix and the LOS 60 GHz or E-band antenna 720-3 includes a flat antenna located within a region defined by the 2×2 matrix of the four dipole antennas. Similarly, FIG. 4A depicts that the NLOS Sub-6 GHz antennas 710-3 include four microstrip antennas defining a square region and the LOS 60 GHz or E-band antenna 720-3 includes a flat antenna located within the square region.

In sum, the universal LOS and NLOS small cell backhaul radio disclosed in the present application provides both traffic independently in two frequency bands (e.g., 5 GHz and 60 GHz). The total throughput of the backhaul radio is the combination of both traffics in normal operation. During normal operations, the Sub-6 GHz NLOS channel and the 60 GHz/E-band LOS channel work simultaneously and provide the maximum throughput. But when either the Sub-6 GHz or 60 GHz/E-band channel fails due to, e.g., in-band interference, blockage, multipath fading or simply hardware failure, etc., the backhaul radio supports the automatic hitless switching between the two communication channels.

While particular implementations are described above, it will be understood it is not intended to limit the invention to these particular implementations. On the contrary, the invention includes alternatives, modifications and equivalents that are within the spirit and scope of the appended claims. Numerous specific details are set forth in order to provide a thorough understanding of the subject matter presented herein. For example, the dual-band backhaul radio design can be extended to other NLOS and LOS frequency combinations, e.g., 2.4 GHz or 2.6 GHz in the NLOS bands combined with E-band in the LOS bands. Moreover, the dual-band design can be further extended to a triple-band design, i.e., selective switching bands in NLOS in combination with either 60 GHz or E-band in LOS bands. But it will be apparent to one of ordinary skill in the art that the subject matter may be practiced without these specific details. In other instances, well-known methods, procedures, components, and circuits have not been described in detail so as not to unnecessarily obscure aspects of the implementations.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present application. First ranking criteria and second ranking criteria are both ranking criteria, but they are not the same ranking criteria.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A dual-band small cell backhaul radio, comprising:
a first communication channel including multiple non-line of sight (NLOS) Sub-6 GHz antennas;
a second communication channel including a line of sight (LOS) 60 GHz or E-band antenna;
circuitry for managing the first communication channel and the second communication channel; and
an interface for providing data and power from a small cell to the first communication channel and the second communication channel, respectively.

2. The dual-band small cell backhaul radio of claim 1, wherein the first communication channel further includes:
a Sub-6 GHz MIMO modem; and
multiple RF transceivers, each RF transceiver configured for coupling a respective NLOS Sub-6 GHz antenna to a corresponding channel of the Sub-6 GHz MIMO modem.

3. The dual-band small cell backhaul radio of claim 1, wherein the second communication channel further includes:
a 60 GHz or E-band modem; and
a 60 GHz or E-band RF transceiver configured for coupling the LOS 60 GHz or E-band antenna to the 60 GHz or E-band modem.

4. The dual-band small cell backhaul radio of claim 1, wherein the circuitry for managing the first communication channel and the second communication channel further includes:
a microcontroller unit for controlling components associated with the NLOS Sub-6 GHz antennas and the LOS 60 GHz or E-band antenna, respectively;
a FPGA-based network processor for processing data packets to/from the small cell;
a SyncE/1588 synchronizer for synchronizing timing, phase, and frequency of the data packets;
a memory device for storing modules and data supporting the microcontroller unit and the network processor; and
a circuit for receiving power over the Ethernet from the small cell and using the power to power the NLOS Sub-6 GHz antennas and the LOS 60 GHz or E-band antenna and their associated components.

5. The dual-band small cell backhaul radio of claim 1, wherein the NLOS Sub-6 GHz antennas include four dipole antennas arranged in a 2×2 matrix and the LOS 60 GHz or E-band antenna includes a flat antenna located within a region defined by the 2×2 matrix of the four dipole antennas.

6. The dual-band small cell backhaul radio of claim 5, wherein the flat antenna is located behind a cover that has four through holes located at its four corners, and each of the four dipole antennas is exposed outside the cover by extending through a respective through hole.

7. The dual-band small cell backhaul radio of claim 1, wherein the NLOS Sub-6 GHz antennas include four microstrip antennas defining a square region and the LOS 60 GHz or E-band antenna includes a flat antenna located within the square region.

8. The dual-band small cell backhaul radio of claim 7, wherein both the flat antenna and the four microstrip antennas surrounding the flat antenna are located behind a cover.

9. The dual-band small cell backhaul radio of claim 1, wherein the dual-band small cell backhaul radio is mechanically attached to a 2-axis active alignment bracket assembly, which is mechanically tunable to align the NLOS Sub-6 GHz antennas and the LOS 60 GHz or E-band antenna with counterparts of another small cell backhaul radio.

10. The dual-band small cell backhaul radio of claim 9, wherein the 2-axis active alignment bracket assembly receives power and control signals from the dual-band small cell backhaul radio.

11. The dual-band small cell backhaul radio of claim 10, wherein, in response to the control signals, the 2-axis active alignment bracket assembly automatically steers beam angles of the NLOS Sub-6 GHz antennas and the LOS 60 GHz or E-band antenna to align the dual-band small cell backhaul radio with another backhaul radio supporting a neighboring small cell or macro cell.

12. The dual-band small cell backhaul radio of claim 1, wherein the LOS 60 GHz or E-band antenna further includes a plurality of antennas and a phase and amplitude network coupled to the plurality of antennas, the phase and amplitude network being electrically tunable to align the plurality of antennas with counterparts of another small cell backhaul radio.

13. The dual-band small cell backhaul radio of claim 1, wherein the LOS 60 GHz or E-band antenna further includes a plurality of antennas, each antenna being aligned with a counterpart of another small cell backhaul radio using digital beam forming.

14. The dual-band small cell backhaul radio of claim 1, wherein the NLOS Sub-6 GHz antennas have a beam angle of 40° and the LOS 60 GHz or E-band antenna has a beam angle of 3-4°.

15. The dual-band small cell backhaul radio of claim 1, wherein the NLOS Sub-6 GHz antennas have an operating frequency selected from the group consisting of 2.4 GHz, 2.6 GHz, 3.5 GHz, 5 GHz, 5.4 GHz, and 5.8 GHz.

16. The dual-band small cell backhaul radio of claim 1, wherein the first communication channel has a data transmission capacity of up to 600 Mbps and a channel bandwidth ranging from 10 MHz to 40 MHz.

17. The dual-band small cell backhaul radio of claim 1, wherein the second communication channel has a data transmission capacity of at least 2.5 Gbps and a channel bandwidth ranging from 250 MHz to 500 MHz.

18. The dual-band small cell backhaul radio of claim 1, wherein the first communication channel and the second communication channel are configured to operate simultaneously.

19. The dual-band small cell backhaul radio of claim 1, wherein the circuitry is configured to perform an automatic hitless switching from one of the first communication channel and the second communication channel and the other one of the first communication channel and the second communication channel when a predefined condition is met.

20. The dual-band small cell backhaul radio of claim 19, wherein the predefined condition is that a respective communication channel stops working due to a band interference, a blockage, multipath fading, and hardware failure.
